(19) United States
(12) Patent Application Publication
(10) Pub. No.: US 2006/0226215 A1
(43) Pub. Date: Oct. 12, 2006

(54) Pattern identification system for an automatic teller machine

(75) Inventors: Kun-Lang Yu, Keelung (TW); Ching-Fuh Lin, Taipei Hsien (TW); Andy Cheng, Taipei (TW)

Correspondence Address: BIRCH STEWART KOLASCH & BIRCH, PO BOX 747, FALLS CHURCH, VA, 22040-0747, US

(73) Assignee: Top Digital Co., Ltd.

(21) Appl. No.: 11/099,566

(22) Filed: Apr. 6, 2005

(51) Int. Cl. G07F 19/00; G06K 5/00

(52) U.S. Cl. 235/379; 235/380

(57) ABSTRACT

A pattern identification system for an automatic teller machine includes an illumination device, a video camera unit, a controller and a programmable identification element. The illumination device initially projects light on a sample or security pattern. The controller controls the video camera to magnify an image sufficient for identification at the predetermined position of the sample or security pattern so as to allow capturing an identifiable image of difference with respect to a programmed feature. The video camera unit captures the identifiable image of the predetermined position of the sample or security pattern and sends it to the programmable identification element for processing identification of the sample or security pattern.

### BACKGROUND OF THE INVENTION

1. Field of the Invention

The present invention relates to a pattern identification system for an automatic teller machine. More particularly, the present invention relates to the automatic teller machine having the pattern identification system for processing and identifying an image of a pattern of an authorized card.

2. Description of the Related Art

In financial market, there are several counterfeits of cash or credit cards in attempting to practice deception. A lot of client information are recently stolen or leaked repeatedly from banking institutions for counterfeiting cash or credit cards. New high-tech equipments may improve and aid the technology for counterfeiting the cash or credit card. Because of this, an ordinary automatic teller machine cannot identify counterfeits of cash or credit cards. Such counterfeits of cash or credit cards may continuously succeed in stealing bank deposits saved in the banking institutions, namely, accomplishing high successful rate for cheating the banking institutions. Such a high successful rate may encourage gangsters for counterfeiting cash or credit cards. Consequently, the banking institutions must suffer a great deal of damage when counterfeit cash or credit cards always succeed in stealing bank deposits or credit payment.

Currently, the technologies for computer color printing has been continuously progressed that encourages to widely spread forging and copies and aids in improving the counterfeit technologies for cash or credit cards. Particularly, the unauthorized cash or credit cards counterfeited by high-tech equipments are hard to be identified and can easily pass the automatic teller machine. Hence, there is a need for a pattern identification system or apparatus for identifying the unauthorized cash or credit cards.

Conventionally, an ordinary cash or credit card only provides with a laser-printed pattern for security purpose. Like even the conventional automatic teller machine, a built-in card reader is only focused on reading out or identifying a magnetic tape of the cash or credit cards. A counterfeit cash or credit card with illegal client information can easily pass ordinary security measures of the automatic teller machine once the client information is stolen from the banking institutions.

However, at least one unique safety measure such as an identifiable pattern must be added on cash or credit cards such that one feature of printing line structure, printing color spectrum and ink material may be used to identify a counterfeit cash or credit card.

The present invention intends to provide a pattern identification system for an automatic teller machine which can process and identify an image of a pattern of an authorized card before dealing financial business in such a way to mitigate and overcome the above problem.

### SUMMARY OF THE INVENTION

The primary objective of this invention is to provide a pattern identification system for an automatic teller machine so as to process and identify an image of a pattern of an authorized card before dealing financial business. Thereby, the pattern identification system may operate the automatic teller machine at the lower risk of stealing bank deposit or succeeding in credit card fraud so that safety for financial business is increased.

The secondary objective of this invention is to provide the pattern identification system for an automatic teller machine. The pattern identification system includes a video camera unit for magnifying an image of a sample or security pattern with a predetermined magnifying times and capturing an identifiable image of difference. Thereby, a programmable identification element is capable of identifying the identifiable image so that identification for cash or credit card is provided.

The pattern identification system for an automatic teller machine in accordance with the present invention includes an illumination device, a video camera unit, a controller and a programmable identification element. The illumination device initially projects light on a sample or security pattern. The controller controls the video camera to magnify an image sufficient for identification at the predetermined position of the sample or security pattern so as to allow capturing an identifiable image of difference with respect to a programmed feature. The video camera unit captures the identifiable image of the predetermined position of the sample or security pattern and sends it to the programmable identification element for processing identification of the sample or security pattern.

In a separate aspect of the present invention is that the illumination device projects a particular wavelength and brightness of light on the sample pattern so as to allow the video camera unit capturing the image of the sample or security pattern.

In a further separate aspect of the present invention is that the pattern identification system further includes a display unit for displaying an identified result of the sample or security pattern or identifying procedure.

In a further separate aspect of the present invention is that the pattern identification system further includes a memory device for storing data of identification for cash or credit cards.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective cutaway view of an automatic teller machine having a pattern identification system in accordance with a preferred embodiment of the present invention;

FIG. 2 is an enlarged sectional view of the automatic teller machine having the pattern identification system in preparing for receiving an authorized card in accordance with a first embodiment of the present invention;

FIG. 3 is an enlarged sectional view of the automatic teller machine having the pattern identification system after receiving an authorized card for identifying operation in accordance with the first embodiment of the present invention;

FIG. 4 is a flow chart of the pattern identification system applied to the automatic teller machine in accordance with a preferred embodiment of the present invention;

FIG. 5 is an enlarged sectional view, similar to FIG. 2, of the automatic teller machine having the pattern identification system in preparing for receiving an authorized card in accordance with a second embodiment of the present invention;

FIG. 6 is an enlarged sectional view, similar to FIG. 3, of the automatic teller machine having the pattern identification system after receiving an authorized card for identifying operation in accordance with the second embodiment of the present invention;

FIG. 7 is an enlarged sectional view, similar to FIG. 2, of the automatic teller machine having the pattern identification system in preparing for receiving an authorized card in accordance with a third embodiment of the present invention; and

FIG. 8 is an enlarged sectional view, similar to FIG. 3, of the automatic teller machine having the pattern identification system after receiving an authorized card for identifying operation in accordance with the third embodiment of the present invention.

### DETAILED DESCRIPTION OF THE INVENTION

The term “authorized card” defined in the present invention includes a cash card, a credit card, an ATM card, an IC card and a combo card etc. The pattern identification system in accordance with the present invention may be incorporated into a variety of Automatic Teller Machines or the like. An Automatic Teller Machine having the pattern identification system is exemplified in embodiments of the present invention. It should be appreciated that the pattern identification system incorporated with a variety of the other Automatic Teller Machines in accordance with the present invention may be implemented and are within the scope of the present invention.

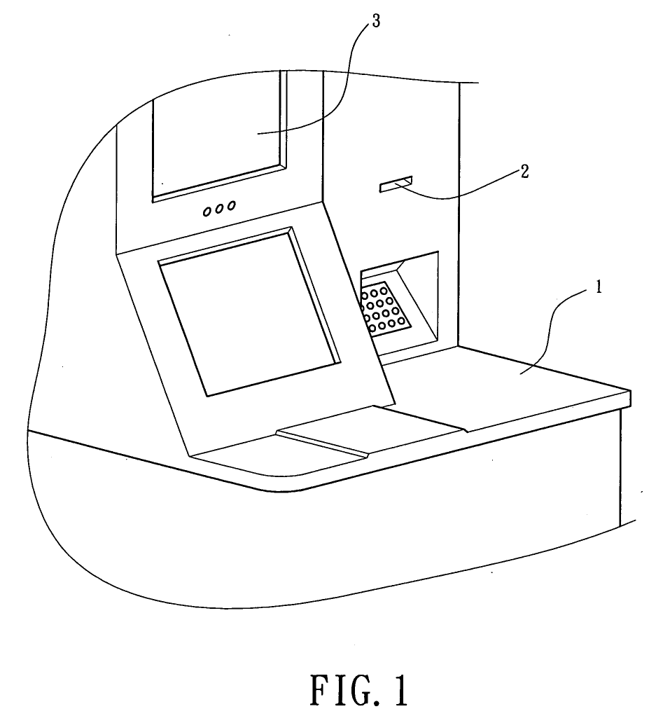

Referring initially to FIGS. 1 through 3, an automatic teller machine 1 having the pattern identification system in accordance with the first embodiment of the present invention includes a card socket 2 and a display unit 3. The card socket 2 houses the pattern identification system, and is provided with a slot (not labeled) which permits receiving or ejecting an authorized card. The pattern identification system includes a substrate 20, an illumination device 21, a video camera unit 22, a controller 23 and a programmable identification element 24. The substrate 20 electrically connects to the illumination device 21, the video camera unit 22, the controller 23 and the programmable identification element 24 in place such that a pattern-identifying function for the automatic teller machine 1 is provided.

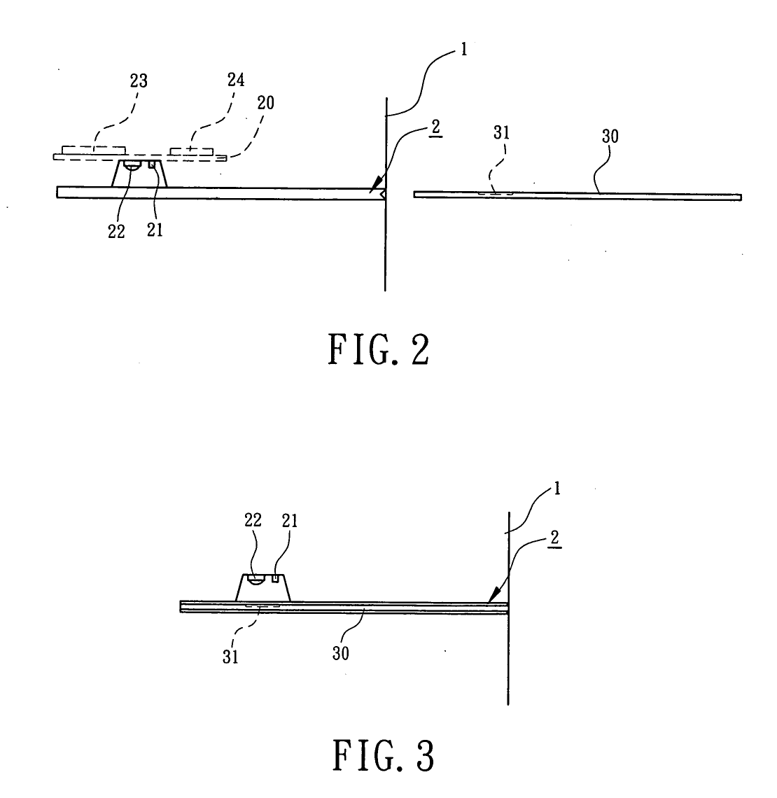

Still referring to FIGS. 2 and 3, the illumination device 21 and the video camera unit 22 are mounted to predetermined positions of the slot of the card socket 2. The illumination device 21 and the video camera unit 22 face the slot of the card socket 2 such that the illumination device 21 is capable of projecting light on the authorized card while being inserted into the slot, and then the video camera unit 22 is capable of capturing an image of the card. Furthermore, the illumination device 21 and the video camera unit 22 are housed in a housing (not labeled) of the automatic teller machine 1. Consequently, one of the illumination device 21 and the video camera unit 22 may not be exposed on the housing of the automatic teller machine 1.

Still referring to FIGS. 2 and 3, as to the controller 23 and the programmable identification element 24, the substrate 20 such as a motherboard has installation spaces for mounting the controller 23 and the programmable identification element 24 so as to form a single board unit. Consequently, the substrate 20 is capable of accomplishing both functions of identifying the authorized card and dealing financial business at a time, namely, accomplishing an additional function of identifying the authorized card in addition to the fundamental function of dealing financial business. The substrate 20 electrically connects and mounts to the illumination device 21, the video camera unit 22, the controller 23, the programmable identification element 24 and the display unit 3.

Still referring to FIGS. 2 and 3, an authorized card 30 may be a cash card, a credit card or a trust card. A surface of the authorized card 30 provides with a security pattern 31 which can be identified by the pattern identification system of the automatic teller machine 1. The security pattern 31 can be selected from a group consisting of laser-printed patterns, iridescent shifting ink patterns and color patterns etc. In manufacture, the security pattern 31 is embedded or stuck onto the surface of the authorized card 30 or faced with a transparent cover that prevents the security pattern 31 from scraping or peeling.

Still referring to FIGS. 2 and 3, in the illustrated first embodiment, the illumination device 21 can be selected from a group consisting of a light emitting diode, a laser illuminator or other particular light wavelength sources which can emit or generate light of red, green, blue, infrared, ultraviolet etc. The controller 23 controls the illumination device 21 and the video camera unit 22 for operating at the same time. The illumination device 21 can selectively projects a particular wavelength and brightness of light on a predetermined position of the authorized card 30 according to features of the authorized card 30 such that the video camera unit 22 can capture an image of the security pattern 31 of the authorized card 30. In the illustrated first embodiment, the illumination device 21 is preferably mounted on the card socket 2.

Still referring to FIGS. 2 and 3, in the illustrated first embodiment, the video camera unit 22 preferably includes a magnifying camera lens having a predetermined magnification rate which is adapted to magnify the security pattern 31 with a predetermined magnification rate. The camera device 31 then captures a reflecting image of the security pattern 31 projected by the illumination device 20. At the slot of the card socket 2, the video camera unit 22 is positioned at a predetermined position and distance above the authorized card 30 which is inserted into the slot of the card socket 2. In the illustrated first embodiment, the video camera unit 22 is preferably mounted on the card socket 2.

Still referring to FIGS. 2 and 3, in the illustrated first embodiment, arranged on the periphery of the video camera unit 22 is the illumination device 21. In an alternative embodiment, the illumination device 21 surrounds the video camera unit 22 for uniformly illuminating around the video camera unit 22. In the illustrated first embodiment, the illumination device 21 may be spaced a predetermined distance from the video camera unit 22.

Referring again to FIGS. 1 and 2, in the illustrated first embodiment, the controller 23 may be selected from a group consisting of a control logical circuit, a control IC and a Central Processing Unit. The controller 23 electrically connects the illumination device 21, the video camera unit 22, the controller 23, the programmable identification element 24 and the display unit 3 such that the automatic teller machine 1 is capable of processing identification for the authorized card 30.

Referring again to FIG. 2, in the illustrated first embodiment, the programmable identification element 24 may be an identification logical circuit or an identification IC programmed by a computer software. For example, a credit card such as a Master card issued by a first bank may include a common feature necessitating a first identification logic, and another credit card such as a Visa card issued by a second bank may include another common feature necessitating a second identification logic. To accomplish identifying a variety of features of authorized cards, the automatic teller machine 1 may include a changeable identification element 24. Accordingly, the programmable identification element 24 of the pattern identification system may be changed according to the features of the authorized card 30. In an alternative embodiment, the automatic teller machine 1 may include an additional card socket (not shown) for changing the programmable identification element 24.

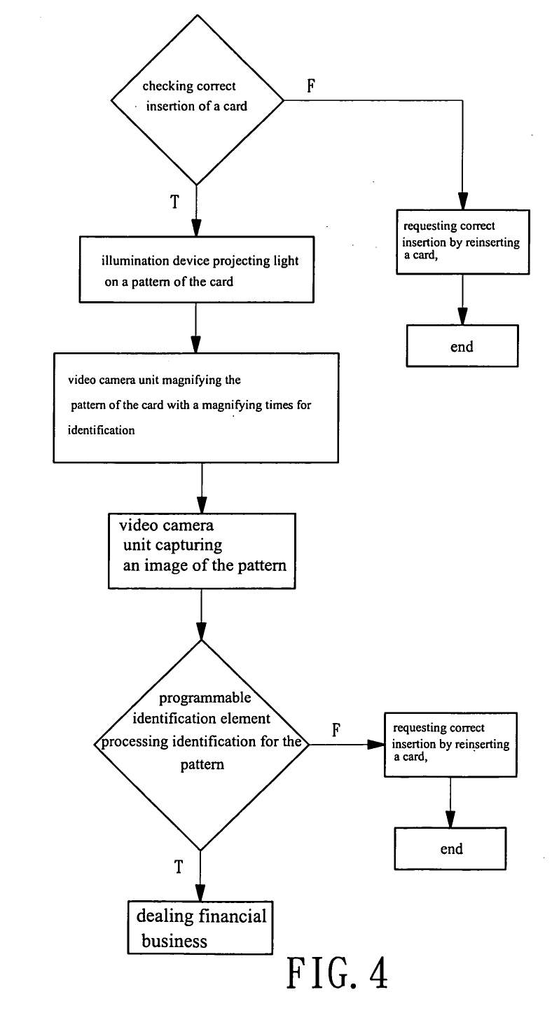

Turning now to FIG. 4, a flow chart of the pattern identification system applied to the automatic teller machine in accordance with the present invention is illustrated. The identification process mainly includes five steps for identifying an authorized card. Once inserted the authorized card 30 into the card socket 2, the identification process for the authorized card 30 may be accomplished within five steps as described more fully below.

Still referring to FIGS. 2 and 4, in first step, before dealing financial business, the automatic teller machine 1 checks correct or incorrect insertion for the authorized card 30 into the card socket 2. Namely, the automatic teller machine 1 checks insertion of a correct direction for the authorized card 30 with respect to the card socket 2. In the illustrated first embodiment, the display unit 3 may display information for correct or incorrect insertion of the authorized card 30. In an alternative embodiment, the card socket 2 may include a guiding member (not shown) for orienting correct insertion of the authorized card 30. The pattern identification system may automatically process an identification procedure with following steps if the authorized card 30 is correctly inserted into the card socket 2. The identification procedure of the pattern identification system in accordance with the present invention may display on the display unit 3. Conversely, the pattern identification system may not continue an identification procedure if the authorized card 30 is incorrectly or incompletely inserted into the card socket 2. Consequently, the pattern identification system may request correct insertion by reinserting the authorized card 30 and then automatically terminate the identification procedure to refuse dealing financial business.

Referring now to FIGS. 3 and 4, in second step, the controller 23 may control to actuate the illumination device 21 if a complete insertion of the authorized card 30 into the card socket 2 is confirmed. The illumination device 21 may project a predetermined wavelength and brightness of light on the security pattern 31 of the authorized card 30 in preparing for capturing a predetermined image.

Referring again to FIGS. 2 through 4, in third step, the controller 23 may control to actuate the video camera unit 22 in response to the illumination device 21 projecting a light beam on the security pattern 31 of the authorized card 30. In capturing operation, the video camera unit 22 can subsequently magnify an image of the security pattern 31 of the authorized card 30 with a predetermined magnifying times sufficient for identification. The image of the security pattern 31 of the authorized card 30 with the magnifying times can accomplish a legal image (e.g. a programmed image) distinguished from a counterfeit image. Because of this, the magnifying times processed by the video camera unit 22 are capable of capturing an identifiable image of difference with respect to a programmed feature.

Still referring to FIGS. 2 through 4, in fourth step, the controller 23 may further control to actuate the video camera unit 22 in response to the video camera unit 22 accomplishing the magnified image of the security pattern 31 of the authorized card 30. If the identifiable image of the security pattern 31 of the authorized card 30 is focused, the video camera unit 22 further serves to capture the identifiable image of the security pattern 31 of the authorized card 30 in the event.

Still referring to FIGS. 2 through 4, in fifth step, the controller 23 may finally control the video camera unit 22 to output the identifiable image of the security pattern 31 of the authorized card 30 to the programmable identification element 24 in response to the video camera unit 22 capturing the image. The controller 23 may further control the programmable identification element 24 to identify the image of the security pattern 31 of the authorized card 30. In identifying operation, the programmable identification element 24 may identify a variety of identifiable features of the security pattern 31 of the authorized card 30.

The identifiable features of the security mark 31 programmed in the programmable identification element 24 includes a variety of unique printing features consisting of printing line structure, raised ink, pattern structure, printing color, printing material, fiber property, fiber component and fiber density etc. As to the difference between the real image and the counterfeit image, a variety of printing line construction, color distribution and material of the pattern are included. The display unit 3 may display an identified result of the security pattern 31 of the authorized card 30 or identifying procedure.

Referring to FIGS. 1 through 4, the automatic teller machine 1 permits dealing financial business with the authorized card 30 if the security pattern 31 of the authorized card 30 can pass the identification procedure of the pattern identification system. Meanwhile, the authorized card 30 can operate the automatic teller machine 1 following directions displayed on the display unit 3. Conversely, the automatic teller machine 1 may refuse the authorized card 30 if the counterfeit pattern of an unauthorized card cannot pass the identification procedure of the pattern identification system. Thereby, the pattern identification system may request correct insertion of an authorized card or reinserting an authorized card, and the automatic teller machine 1 may automatically terminate dealing financial business.

Referring back to FIG. 1, in an alternative embodiment, the pattern identification system of the automatic teller machine 1 further includes a memory device (not shown) for storing data of identification for the identified cards. Preferably, the memory device may be housed in the automatic teller machine 1 or the banking institution. The identification data received in the memory device may connect to a financial institution or a police department. The identification data includes bank account, processing time and identified result of the authorized card.

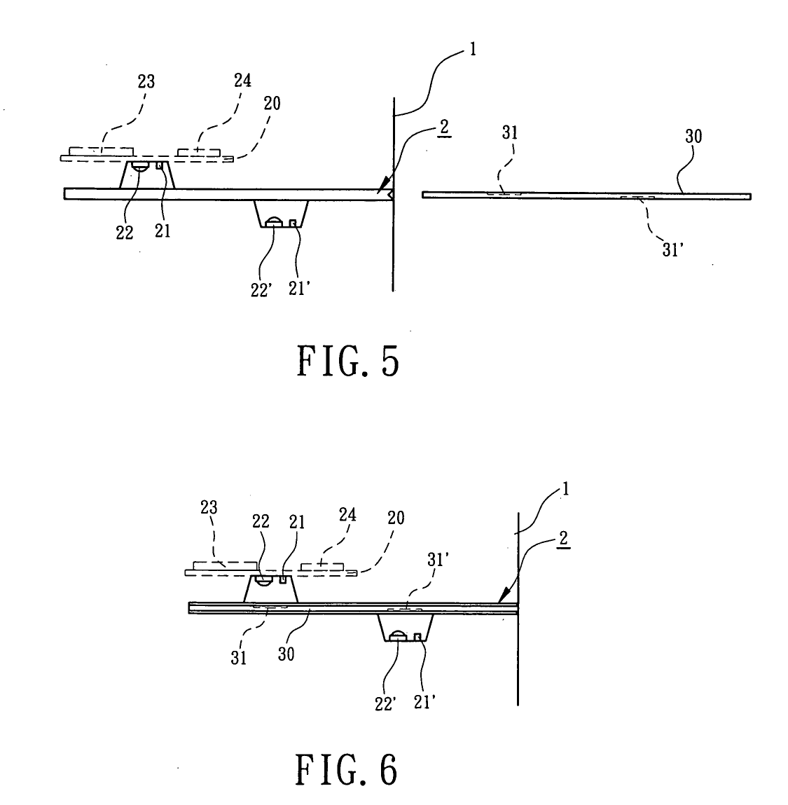

Turning now to FIGS. 5 and 6, reference numerals of the second embodiment of the present invention have applied the identical numerals of the first embodiment. The pattern identification system in accordance with the second embodiment of the present invention has similar configuration and same function as that of the first embodiment and the detailed descriptions may be omitted.

Referring to FIGS. 5 and 6, in comparison with the illustrated first embodiment, the automatic teller machine 1 of the second embodiment includes a card socket 2 and a display unit 3. The card socket 2 houses the pattern identification system, and the pattern identification system includes a substrate 20, a first illumination device 21, a second illumination device 21′, a first video camera unit 22, a second video camera unit 22′, a controller 23 and a programmable identification element 24. The substrate 20 electrically connects to the illumination devices 21, 21′, the video camera units 22, 22′, the controller 23 and the programmable identification element 24 in place such that a pattern-identifying function for the automatic teller machine 1 is provided.

Still referring to FIGS. 5 and 6, in the illustrated second embodiment, two of the illumination devices 21, 21′ and two of the video camera units 22, 22′ are used to project on the security patterns 31, 31′ of the authorized card 30 in increasing reliability for identification. However, it should be appreciated that three or more illumination devices may still remain within the scope of the present invention. Also, it should be appreciated that three or more video camera units may still remain within the scope of the present invention.

Still referring to FIGS. 5 and 6, in the illustrated second embodiment, the first illumination devices 21 is coupled to the first video camera units 22 so that the illumination device 21 and the video camera unit 22 are commonly mounted to a position above the card socket 2. Conversely, the second illumination device 21′ is coupled to the second video camera unit 22′ so that the illumination device 21′ and the video camera units 22′ are commonly mounted to a position below the card socket 2. It should be appreciated that the illumination devices 21, 21′ and the video camera units 22, 22′ face an upper surface and a lower surface of the authorized card 30.

In another embodiment, the illumination devices 21, 21′ and the video camera units 22, 22′ may only face the upper surface of the authorized card 30 so that multiple security patterns 31, 31′ disposed on the upper surface of the authorized card 30 can be identified at a time. In yet another embodiment, the illumination devices 21, 21′ and the video camera units 22, 22′ may only face the lower surface of the authorized card 30 so that multiple security patterns 31 disposed on the lower surface of the authorized card 30 can be identified at a time.

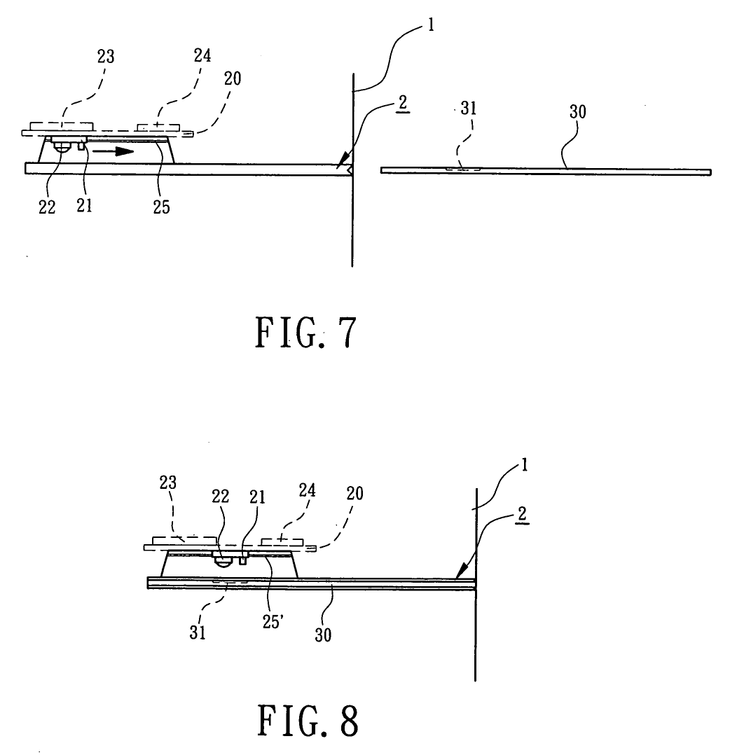

Turning now to FIGS. 7 and 8, reference numerals of the third embodiment of the present invention have applied the identical numerals of the first embodiment, as shown in FIGS. 1 through 4. The pattern identification system in accordance with the third embodiment of the present invention has similar configuration and same function as that of the first embodiment and the detailed descriptions may be omitted.

Referring to FIGS. 7 and 8, in comparison with the illustrated first embodiment, the automatic teller machine of the third embodiment includes a card socket 2 and a display unit 3. The card socket 2 provides the pattern identification system and includes a substrate 20, an illumination device 21, a video camera unit 22, a controller 23, a programmable identification element 24 and at least one slide track mechanism 25. The substrate 20 electrically connects to the illumination device 21, the video camera unit 22, the controller 23, the programmable identification element 24 and the slide track mechanism 25.

Referring again to FIG. 7, in comparison with the illustrated first embodiment, the slot of the card socket 2 provides with the slide track mechanism 25 and permits receiving a variety of sizes of the authorized card 30. However, it should be appreciated that the slide track mechanism 25 permits the illumination device 21 and the video camera unit 22 processing a variety of different positions of the security patterns 31 of the authorized cards 30. The illumination device 21 and the video camera unit 22 are slidably mounted on a slide track of the slide track mechanism 25 so as to move (e.g. in the direction of arrow in FIG. 7) and position at a point where the illumination device 21 and the video camera unit 22 are in perfect alignment with the security pattern 31 of the authorized card 30. In operation, the controller 23 may control the illumination device 21 and the video camera unit 22 to move along the slide track of the slide track mechanism 25.

Referring again to FIG. 8, the controller 23 controls the illumination device 21 and the video camera unit 22 to automatically move to a predetermined point in the card socket 2 once the authorized card 30 is completely inserted into the slot of the card socket 2. Consequently, the pattern identification system of the automatic teller machine 1 may automatically begin to process the identification steps, as best shown in FIG. 4, if the illumination device 21 and the video camera unit 22 are positioned.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A pattern identification system for an automatic teller machine, comprising:
a substrate arranged within the automatic teller machine;
at least one illumination device arranged in a card socket which is formed on the automatic teller machine and adapted to receive a card, said card having a pattern for identification, said illumination device electronically connected to the substrate and used to project light on the card;
at least one video camera unit used to magnify an image of the pattern of the card with a predetermined magnifying times to obtain an identifiable image of difference sufficient for identification;
a controller electronically connected to the substrate, and further electronically connected to the illumination device and the video camera unit for capturing the identifiable image of the pattern; and
a programmable identification element electronically connected to the substrate, and further electronically-connected to the controller and the video camera unit, the programmable identification element including a recognizing logic for identifying the identifiable image so as to generate a difference between the identifiable image and the recognizing logic, and the programmable identification element used to identify the identifiable image outputted from the video camera unit;
wherein the controller controls the video camera unit to output the identifiable image to the programmable identification element for identification.

2. The pattern identification system for the automatic teller machine as defined in claim 1, further comprising a display unit to display identification results required for dealing financial business.

3. The pattern identification system for the automatic teller machine as defined in claim 1, wherein the illumination device projects a particular wavelength and brightness of light according to various types of the pattern.

4. The pattern identification system for the automatic teller machine as defined in claim 1, wherein the programmable identification element is selected from a group consisting of an identification logical circuit and an identification IC.

5. The pattern identification system for the automatic teller machine as defined in claim 1, wherein the programmable identification element is able to identify one or more features consisting of printing line structures, pattern structures, printing colors and printing materials.

6. The pattern identification system for the automatic teller machine as defined in claim 1, wherein the pattern is embedded in or stuck onto a surface of the card or faced with a transparent cover.

7. The pattern identification system for the automatic teller machine as defined in claim 11, wherein the pattern contain information for identification of true/false patterns.

8. The pattern identification system for the automatic teller machine as defined in claim 1, wherein automatic teller machine further comprising an additional card socket for changing the programmable identification element.

9. The pattern identification system for the automatic teller machine as defined in claim 1, further comprising a memory device for storing identification data of the card, the memory device is housed in the automatic teller machine or a banking institution and the identification data is connected to a financial institution or a police department for checking

10. The pattern identification system for the automatic teller machine as defined in claim 9, wherein the identification data includes bank account, processing time and identified result of the card.

11. The pattern identification system for the automatic teller machine as defined in claim 1, further comprising an illumination device and a video camera unit so that two of the illumination devices and two of the video camera units for multiple patterns of the card is provided.

12. The pattern identification system for the automatic teller machine as defined in claim 11, wherein the two illumination devices and the two video camera units are mounted to positions above and below the card socket so as to capture an upper surface and a lower surface of the card.

13. The pattern identification system for the automatic teller machine as defined in claim 11, wherein the two illumination devices and the two video camera units are mounted to positions above the card socket so as to capture an upper surface of the card.

14. The pattern identification system for the automatic teller machine as defined in claim 1, wherein the two illumination devices and the two video camera units are mounted to positions above the card socket so as to capture a lower surface of the card.

15. The pattern identification system for the automatic teller machine as defined in claim 1, wherein the card socket provides with a slide track mechanism, and the illumination device and the video camera unit are mounted on the slide track mechanism so that the illumination device and the video camera unit can move to a point where the illumination device and the video camera unit are aligned with the pattern on the card.
